(19) United States
(12) Patent Application Publication
(10) Pub. No.: US 2007/0261779 A1
(43) Pub. Date: Nov. 15, 2007

(54) BACKLIGHT UNIT AND METHOD OF MANUFACTURING THE SAME

(75) Inventors: Young-jea SONG, Daegu-si (KR); Jun-ho CHO, Gumi-si (KR)

Correspondence Address: KEVIN J. MCNEELY, ESQ., 5335 WISCONSON AVENUE, NW, SUITE 440, WASHINGTON, DC, 20015, US

(73) Assignee: HYUNWON, INC., Daegu-si (KR)

(21) Appl. No.: 11/548,484

(22) Filed: Oct. 11, 2006

(30) Foreign Application Priority Data
May 10, 2006 (KR) 10-2006-0041947

(51) Int. Cl. B32B 17/00

(52) U.S. Cl. 156/99; 362/330

(57) ABSTRACT

Disclosed is a method of manufacturing a backlight unit, including: forming a plurality of LED recesses and a plurality of electrode recesses on a top surface of a flat panel-shaped lower glass; forming electrode patterns on the electrode recesses to supply current to LEDs; applying adhesives on the LED recesses; fixing the LEDs on the adhesives applied on the LED recesses; and stacking a flat panel-shaped upper glass on the top surface of the lower glass.

This application claims the priority of Korean Patent Application No. 2006-41947, filed on May 10, 2006, in the Korean Intellectual Property Office, the disclosure of which is incorporated herein in its entirety by reference.

### BACKGROUND OF THE INVENTION

1. Field of the Invention

The present invention relates to a backlight unit and a method of manufacturing the backlight unit.

2. Description of Related Art

In recent years, TFT-LCDs (Thin Film Transistor Liquid Crystal Displays) are in great demand among display devices, such as CRT (Cathode Ray Tube), PDP (Plasma Display Panel), LCD (Liquid Crystal Display) and organic electroluminescent (EL) display. TFT-LCDs are a variant of LCD which use Thin-Film Transistor technology to improve their image quality. TFT-LCD roughly consists of the following three core components: a panel with liquid crystal filled between two glass plates; a driver LSI and a PCB (Printed Circuit Board) for driving the panel; and a chassis including a backlight unit.

The backlight unit is the form of illumination used in an LCD display. Its light source can be a cold cathode fluorescent lamp, or one or more light-emitting diodes (LEDs). Recently, the backlight unit employs the LEDs since they have a wide color gamut, high light efficiency, long life, low power consumption, light weight, and thin thickness.

### SUMMARY OF THE INVENTION

The present invention provides a backlight unit and a method of manufacturing the backlight unit.

According to an aspect of the present invention, there is provided a method of manufacturing a backlight unit, including: forming a plurality of LED recesses and a plurality of electrode recesses on a top surface of a flat panel-shaped lower glass; forming electrode patterns on the electrode recesses to supply current to LEDs; applying adhesives on the LED recesses; fixing the LEDs on the adhesives applied on the LED recesses; and stacking a flat panel-shaped upper glass on the top surface of the lower glass.

The method may further include forming a light-guide structure on a bottom surface of the upper glass so that the light emitted from the LEDs can be uniformly diffused.

According to another aspect of the present invention, there is provided a method of manufacturing a backlight unit, including: forming electrode patterns on a flat panel-shaped lower glass; applying adhesives at positions of the lower glass where LEDs are to be attached; fixing the LEDs to the adhesives; forming a plurality of LED recesses on a bottom surface of a flat panel-shaped upper glass; and stacking the upper glass on a top surface of the lower glass so that the LEDs fixed on the lower glass can be placed on the LED recesses of the upper glass.

The method may further include forming a light-guide structure on a bottom surface of each of the LED recesses so that the light emitted from the LEDs can be uniformly diffused.

According to another aspect of the present invention, there is provided a method of manufacturing a backlight unit, including: forming a plurality of LED recesses and a plurality of electrode recesses on a top surface of a flat panel-shaped lower glass; forming electrode patterns on the electrode recesses to supply current to LEDs; performing a process of manufacturing LEDs to be fixed on the LED recesses; and stacking a flat panel-shaped upper glass on the top surface of the lower glass.

The operation of performing a process of manufacturing LEDs may include: fixing LED chips on the LED recesses; electrically connecting the electrode patterns and the LED chips; and molding the LED chips.

The method may further include forming a light-guide structure on a bottom surface of the upper glass so that the light emitted from the LEDs can be uniformly diffused.

According to another aspect of the present invention, there is provided a method of manufacturing a backlight unit, including: forming electrode patterns on a flat panel-shaped lower glass; performing a process of manufacturing LEDs that are fixed on the lower glass and emit light by current supplied from the electrode patterns; forming a plurality of LED recesses on a bottom surface of a flat panel-shaped upper glass; and stacking the upper glass on a top surface of the lower glass so that the LEDs fixed on the lower glass can be placed on the LED recesses of the upper glass.

The operation of performing a process of manufacturing LEDs may include: fixing LED chips on the LED recesses; electrically connecting the electrode patterns and the LED chips; and molding the LED chips.

The method may further include forming diffusion patterns on a top surface of the upper glass to diffuse light emitted from the LEDs.

The method may further include forming a light-guide structure on a bottom surface of each of the LED recesses so that the light emitted from the LEDs can be uniformly diffused.

The method may further include forming a reflector on a bottom surface of the lower glass.

The reflector may be made of a metallic material having a high thermal conductivity.

According to another aspect of the present invention, there is provided a backlight unit including: a flat panel-shaped lower glass having a plurality of LED recesses and a plurality of electrode recesses formed on its top surface; LEDs fixed on the LED recesses; electrode patterns formed on the electrode recesses to supply current to the LEDs; and a flat panel-shaped upper glass stacked on a top surface of the lower glass.

A bottom surface of the upper glass may have a light-guide structure so that light emitted from the LEDs can be uniformly diffused.

According to another aspect of the present invention, there is provided a backlight unit including: a flat panel-shaped lower glass; a plurality of LEDs fixed on the lower glass; a plurality of electrode patterns formed on the lower glass to supply current to the LEDs; and a flat panel-shaped upper glass that has a plurality of LED recesses formed on its bottom surface and is stacked on the lower glass so that the LEDs can be placed on the LED recesses.

The upper glass may have diffusion patterns on its top surface to diffuse light emitted from the LEDs.

A bottom surface of each of the LED recesses may have a light-guide structure so that the light emitted from the LEDs can be uniformly diffused.

The backlight unit may further include a reflector formed on a bottom surface of the lower glass.

The reflector may be made of a metallic material having high thermal conductivity.

### BRIEF DESCRIPTION OF THE DRAWINGS

The above and other features and advantages of the present invention will become more apparent by describing in detail exemplary embodiments thereof with reference to the attached drawings in which:

FIG. 1 is a flow chart of a method of manufacturing a backlight unit according to an embodiment of the present invention;

FIG. 2 is a process-by-process backlight unit according to the method of FIG. 1;

FIG. 3 is a cross-sectional view of the backlight unit manufactured according to the method of FIG. 1;

FIG. 4A is a cross-sectional view of the backlight unit manufactured according to the method of FIG. 1;

FIG. 4B is a cross-sectional view of the backlight unit manufactured according to the method of FIG. 1;

FIG. 4C is a cross-sectional view of the backlight unit manufactured according to the method of FIG. 1;

FIG. 5 is a flow chart of a method of manufacturing a backlight unit according to an embodiment of the present invention;

FIG. 6 is a process-by-process backlight unit according to the method of FIG. 5;

FIG. 7 is a cross-sectional view of the backlight unit manufactured according to the method of FIG. 5;

FIG. 8 is a cross-sectional view of the backlight unit manufactured according to the method of FIG. 5;

FIG. 9 is a flow chart of a method of manufacturing a backlight unit according to an embodiment of the present invention;

FIG. 10 is a process-by-process backlight unit according to the method of FIG. 9;

FIG. 11 is a flow chart of a method of manufacturing a backlight unit according to an embodiment of the present invention;

FIG. 12 is a process-by-process backlight unit according to the method of FIG. 11; and

FIG. 13 illustrates diffusion patterns.

### DETAILED DESCRIPTION OF THE INVENTION

Exemplary embodiments in accordance with the present invention will now be described in detail with reference to the accompanying drawings.

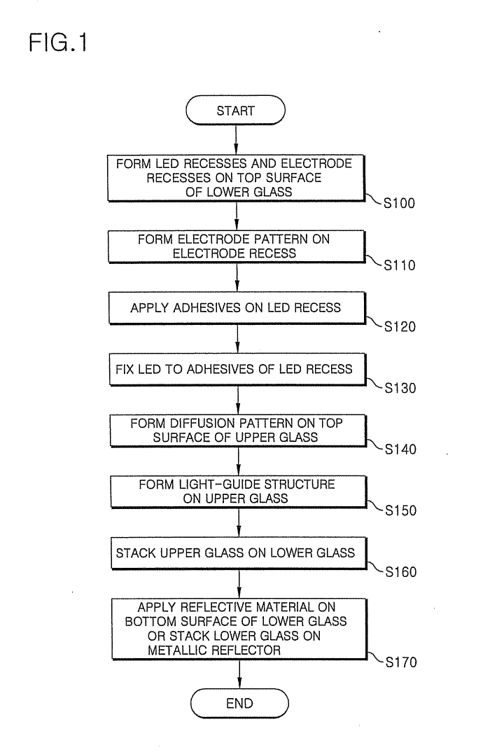

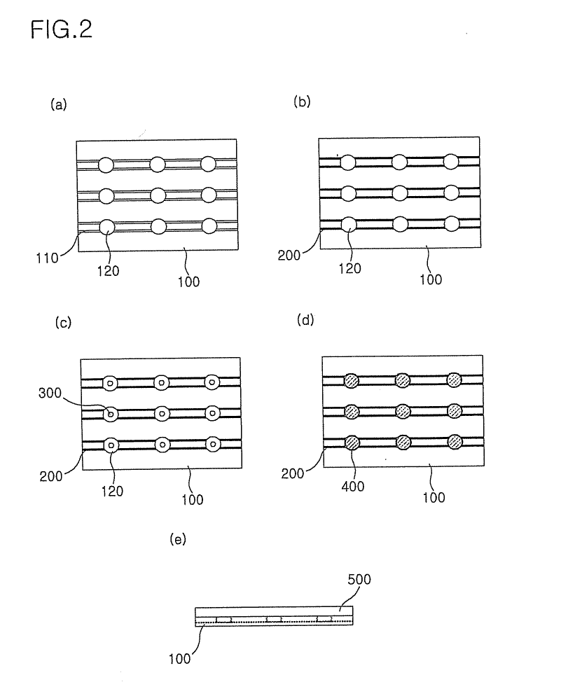

FIG. 1 is a flow chart of a method of manufacturing a backlight unit according to an embodiment of the present invention. FIG. 2 is a process-by-process backlight unit according to the method of FIG. 1.

As shown in FIG. 2(a), a plurality of LED recesses 120 and a plurality of electrode recesses 110 are formed on a top surface of a flat panel-shaped lower glass 100 by etching or sand blaster (operation S100). The depths of the LED recesses 120 are preferably larger than the heights of LEDs to be fixed to the LED recesses 120.

As shown in FIG. 2(b), electrode patterns 200 are formed on the electrode recesses 110 by means of printers and other devices (operation S110). The electrode patterns 200 may be made of Indium Tin Oxide (ITO). However, the electrode patterns 200 are not limited thereto but may be made of other electrical materials. The electrode patterns 200 may be formed by silk screen or other well-known methods.

As shown in FIG. 2(c), after forming the electrode patterns 200, adhesives 300 are applied on the LED recesses 120 by a dispenser (operation S120). As shown in FIG. 2(d), finished LEDs 400 are fixed to the LED recesses 120 with the adhesives 300 by means of Surface Mounting Technology (SMT) equipment (operation S130), and then dried. The LEDs 400 fixed to the LED recesses 120 are electrically connected to the electrode patterns 200. The LEDs 400 receive current from the electrode patterns 200 and give off light. The LEDs 400 are connected in series to one another in column directions and connected in parallel to one another in row directions through the electrode patterns 200. However, the LEDs 400 may be connected to one another differently from the above-mentioned manner.

As shown in FIG. 2(e), after forming the electrode patterns 200 on the lower glass 100 and fixing the LEDs 400 to the LED recesses 120, a flat panel-shaped upper glass 500 having the same size as that of the lower glass 100 is stacked on a top surface of the lower glass 100 (operation S160). That is, the lower glass 100 and the upper glass 500 are joined together. A method of joining the glasses together is well-known in the art and a detailed description thereof will thus be omitted herein.

The method of manufacturing the backlight unit according to the present invention may further include the following operations.

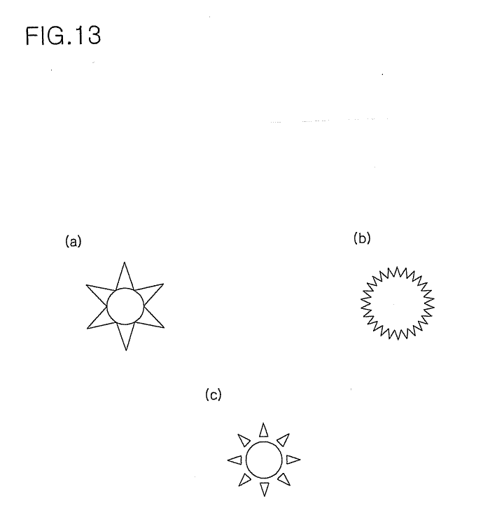

First, diffusion patterns are formed on the top surface of the upper glass 500 (operation S140). The diffusion patterns are preferably formed on the same perpendicular lines with the LEDs 400 placed on the lower glass 100. The diffusion patterns act to diffuse light emitted from the LEDs 400. For this purpose, the diffusion patterns may have shapes shown in FIGS. 13(a), (b) and (c). The diffusion patterns of FIGS. 13(a), (b) and (c) may be formed on the top surface of the upper glass 500 by etching or sand blaster.

Secondly, a bottom surface of the upper glass 500 is formed to have a light-guide structure so that light emitted from the LEDs 400 can be uniformly diffused. The light-guide structure will be discussed below.

Thirdly, a reflective material is applied on the bottom surface of the lower glass 100 (operation S170). Part of the light that is emitted from the LEDs 400 and diffused from the upper glass 500 having the light-guide structure is emitted to the opposite side and wasted. A reflective material having an excellent reflectance is applied on the bottom surface of the lower glass 100 to guide the wasted light back towards the upper glass 500. The reflective material may be AgCl.

The lower glass 100 may be stacked on a reflector made of a metallic material (operation S170). The reflector is preferably made of a metallic material, such as aluminum, with high reflective efficiency and thermal conductivity. A top surface of the reflector contacting the bottom surface of the lower glass 100 is preferably processed to have a smooth, flat surface, thereby enhancing the reflective efficiency.

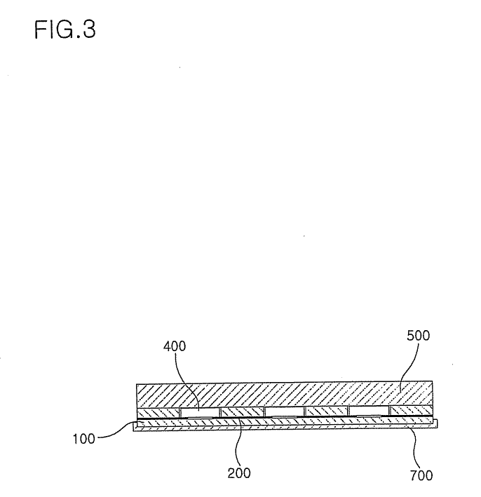

FIG. 3 is a cross-sectional view of the backlight unit manufactured according to the method of FIG. 1.

The flat panel-shaped lower glass 100 has a plurality of electrode recesses 110 and a plurality of LED recesses 120 formed on its top surface. The electrode patterns 200 are formed on the electrode recesses 110 by applying, for example, ITO on the electrode recesses 110. The LEDs 400, which are electrically connected to the electrode patterns 200 and give off light by current supplied from the electrode patterns 200, are fixed to the LED recesses 120. A reflector may be formed on the bottom surface of the lower glass 100 by applying a reflective material on the bottom surface of the lower glass 100. The lower glass 100 may be stacked on a reflector 700. In the latter case, the lower glass 100 may be fixed into the reflector 700 having a shape of

[symbol]

The flat panel-shaped upper glass 500 is stacked on the top surface of the lower glass 100, such that the upper and lower glasses 500 and 100 are unitarily formed.

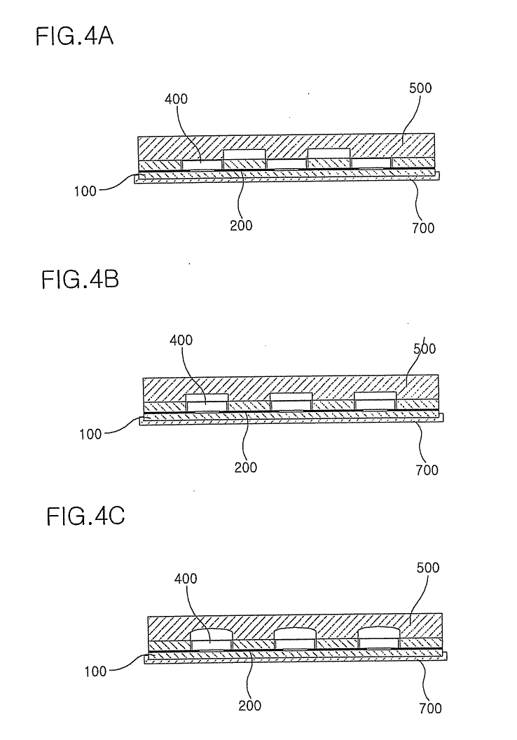

FIGS. 4A, 4B and 4C are cross-sectional views of the backlight unit manufactured according to the method of FIG. 1.

The flat panel-shaped lower glass 100 has a plurality of electrode recesses 110 and a plurality of LED recesses 120 formed on its top surface. The electrode patterns 200 are formed on the electrode recesses 110 by applying ITO on the electrode recesses 110. The LEDs 400, which are electrically connected to the electrode patterns 200 and give off light by current supplied from the electrode patterns 200, are fixed to the LED recesses 120. A reflector may be formed on the bottom surface of the lower glass 100 by applying a reflective material on the bottom surface of the lower glass 100. The lower glass 100 may be stacked on the reflector 700. In the latter case, the lower glass 100 may be fixed into the reflector 700 having a shape of

[symbol]

The flat panel-shaped upper glass 500 has various bottom surfaces as shown in FIGS. 4A, 4B and 4C. Referring to FIG. 4A, the bottom surface of the upper glass 500 is processed such that light-emitting surfaces of the LEDs 400 alternate with each other. Accordingly, the light-emitting surfaces act as a light-guide plate that uniformly diffuses the light emitted from the LEDs 40. In FIGS. 4B and 4C, the bottom surface of the upper glass 500 is processed so that the light emitted from the LEDs 400 can be uniformly diffused.

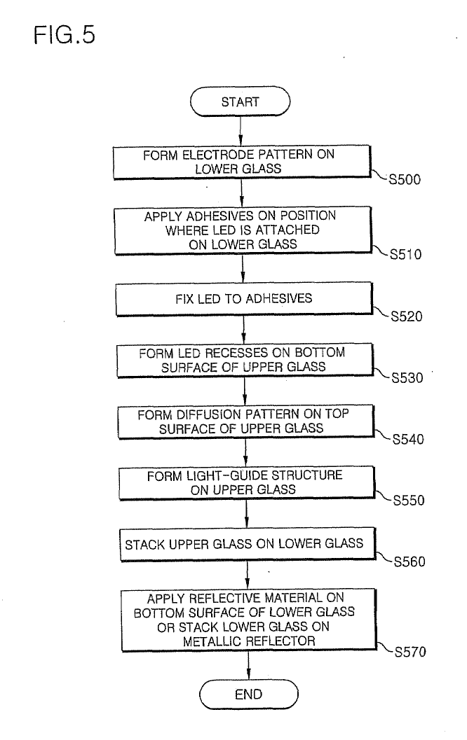

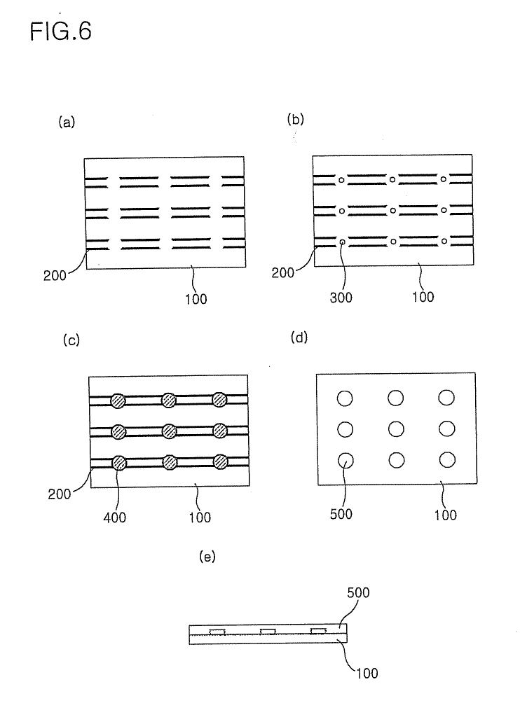

FIG. 5 is a flow chart of a method of manufacturing a backlight unit according to an embodiment of the present invention. FIG. 6 is a process-by-process backlight unit according to the method of FIG. 5.

As shown in FIG. 6(a), a plurality of electrode patterns 200 is formed on a top surface of the flat panel-shaped lower glass 100 by a printer and other apparatuses (operation S500). The electrode patterns 200 may be formed on the electrode recesses after forming a plurality of electrode recesses. The electrode patterns 200 may be made of ITO. The electrode patterns 200 can be formed by the silk screen method.

As shown in FIG. 6(b), after forming the electrode patterns 200, adhesives 300 are applied by a dispenser on positions where the LEDs are fixed (operation S510). As shown in FIG. 6(c), the finished LEDs 400 are fixed to the LED recesses 120 with the adhesives 300 by Surface Mounting Technology (SMT) equipment (operation S520), and then dried. The LEDs 400 fixed to the lower glass 100 are electrically connected to the electrode patterns 200, and give off light by current supplied from the electrode patterns 200. The LEDs 400 fixed on the lower glass 100 are connected in series to one another in column directions and connected in parallel to one another in row directions through the electrode patterns 200. However, the LEDs 400 may be connected to one another differently from the above-mentioned manner.

A plurality of LED recesses 510 is formed on the bottom surface of the flat panel-shaped upper glass 500 by etching or sand blaster (operation S530). The depth of the LED recess 510 is preferably larger than the height of the LED 400 to be inserted into the LED recess 510. The upper glass 500 is stacked on the lower glass 100 so that the LEDs 400 fixed on the lower glass 100 can be inserted into the LED recesses 120 of the upper glass 500 (operation S560). The upper and lower glasses 500 and 100 are joined together. A method of joining the glasses together is well-known in the art and a detailed description thereof will thus be omitted herein.

The method of manufacturing the backlight unit according to the present invention may further include the following operations.

First, diffusion patterns are formed on the top surface of the upper glass 500 (operation S540). The diffusion patterns are preferably formed on the same perpendicular lines with the LEDs 400 placed on the lower glass 100. The diffusion patterns act to diffuse light emitted from the LEDs 400. For this purpose, the diffusion patterns may have shapes shown in FIGS. 13(a), (b) and (c). The diffusion patterns of FIGS. 13(a), (b) and (c) may be formed on the top surface of the upper glass 500 by etching or sand blaster.

Secondly, a bottom surface of the LED recess 510 is formed to have a light-guide structure so that the light emitted from the LEDs 400 can be uniformly diffused (operation S550). The light-guide structure will be described below.

Thirdly, a reflective material is applied on the bottom surface of the lower glass 100 (operation S570). Part of the light emitted from the LED 400 and diffused from the upper glass 500 having the light-guide structure is emitted to the opposite side and wasted. A reflective material having an excellent reflectance is applied on the bottom surface of the lower glass 100 to guide the wasted light back towards the upper glass 500. The reflective material may be AgCl.

The lower glass 100 may be stacked on a reflector made of a metallic material (operation S570). The reflector is preferably made of a metallic material, such as aluminum, with high reflective efficiency and thermal conductivity. A top surface of the reflector contacting the bottom surface of the lower glass 100 is preferably processed to have a smooth, flat surface, thereby enhancing the reflective efficiency.

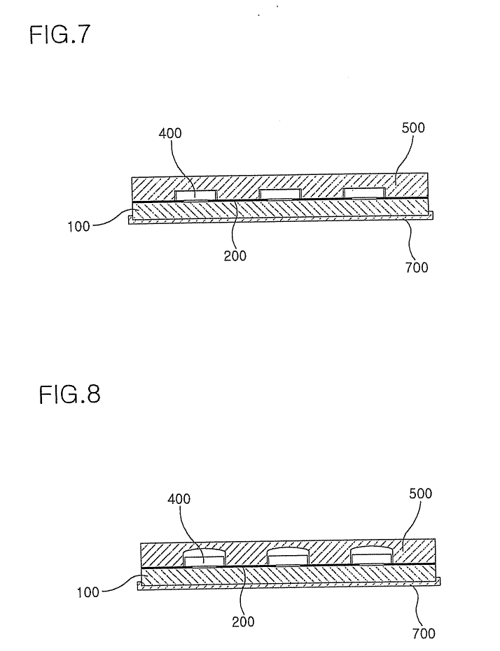

FIG. 7 is a cross-sectional view of the backlight unit manufactured according to the method of FIG. 5.

The flat panel-shaped lower glass 100 has a plurality of electrode patterns 200 and the LEDs 400 formed on its top surface. The LEDs 400 are electrically connected to the electrode patterns 200 and give off light by current supplied from the electrode patterns 200. A reflector may be formed on the bottom surface of the lower glass 100 by applying a reflective material on the bottom surface of the lower glass 100. The lower glass 100 may be stacked on a reflector 700. In the latter case, the lower glass 100 may be fixed into the reflector 700 having a shape of

[symbol]

The flat panel-shaped upper glass 500 has a plurality of LED recesses 510 on its bottom surface. The upper glass 500 is stacked on the top surface of the lower glass 100, such that the upper and lower glasses 500 and 100 are unitarily formed and the LEDs 400 are placed on the LED recesses 510.

FIG. 8 is a cross-sectional view of the backlight unit manufactured according to the method of FIG. 5.

The flat panel-shaped lower glass 100 has a plurality of electrode patterns 200 and the LEDs 400 formed on its top surface. The LEDs 400 are electrically connected to the electrode patterns 200 and give off light by current supplied from the electrode patterns 200. A reflector may be formed on the bottom surface of the lower glass 100 by applying a reflective material on the bottom surface of the lower glass 100. The lower glass 100 may be stacked on a reflector 700. In the latter case, the lower glass 100 may be fixed into the reflector 700 having a shape of

[symbol]

The flat panel-shaped upper glass 500 has a plurality of LED recesses 510 on its bottom surface. The upper glass 500 is stacked on the top surface of the lower glass 100 so that the upper and lower glasses 500 and 100 can be unitarily formed and the LEDs 400 can be placed on the LED recesses 510. As shown in FIG. 8, a bottom surface of the LED recess 120 has a round shape so that light emitted from the LEDs 400 can be uniformly diffused.

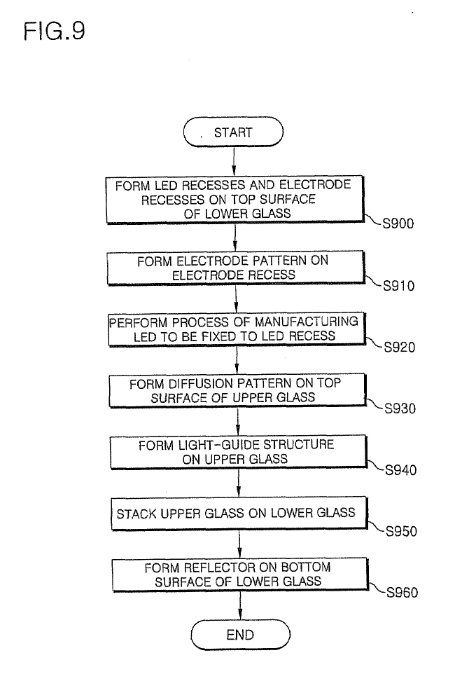

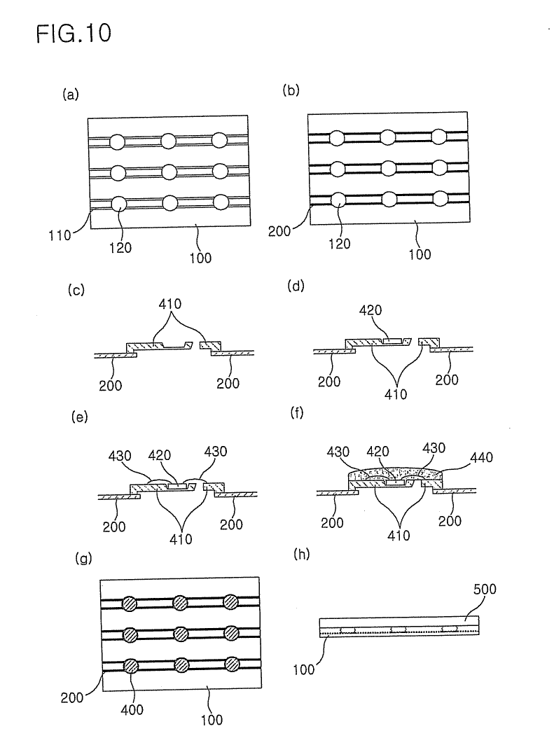

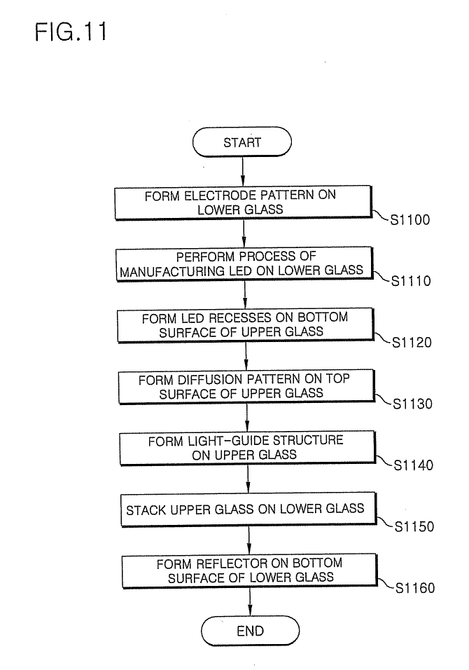

FIG. 9 is a flow chart of a method of manufacturing a backlight unit according to an embodiment of the present invention. FIG. 10 is a process-by-process backlight unit according to the method of FIG. 9.

As shown in FIG. 10(a), a plurality of LED recesses 120 and a plurality of electrode recesses 110 are formed on the top surface of the lower glass by etching or sand blaster (operation S900). The depth of the LED recess 120 is preferably larger than the height of the LED 400 to be inserted to the LED recess 120.

As shown in FIG. 10(b), the electrode patterns 200 are formed on the electrode recesses 110 by a printer and other apparatuses (operation S910). The electrode patterns 200 may be made of ITO. The electrode patterns 200 can be formed by the silk screen method or other well-known methods. After forming the electrode patterns 200, an LED manufacture process is carried out to manufacture LEDs to be fixed into the LED recesses 120 (operation S920).

The LED manufacture process will be descried with reference to FIG. 10. The LED manufacture process includes die bonding, wire bonding, and molding that are carried out in this order. As shown in FIG. 10(c), a lead frame 410 is placed on the LED recess 120, and is electrically connected and fixed to the electrode pattern 200. As shown in FIG. 10(d), an LED chip 420 is fixed on the lead frame 410 by the SMT equipment (Die bonding). Epoxy die bonding may be an example of the die bonding. The epoxy die bonding is one of the most popular methods in which a chip is attached with epoxy to a lead frame.

As shown in FIG. 10(e), after the die bonding, the LED chip 420 and the lead frame 410 are wire-bonded with a gold wire 430. Examples of the bonding method include Thermo Compression (T/C) bonding, Thermo Sonic (T/S) bonding, and Ultra Sonic (U/S) bonding. The T/C bonding is a process that involves the use of pressure and temperature to join two materials by interdiffusion across the boundary. The T/S bonding is a combination of the principle bonding features of ultrasonic and T/C bonding. The U/S bonding is a process in which wire is guided to a bonding site, and pressed onto the surface by a bonding stylus. The wire bonding is well-known in the art and a detailed description thereof will thus be omitted herein.

After the wire bonding, a molding process is carried out to form a convex shape as shown in FIG. 10(f) or other shapes. Examples of the molding method include transfer molding and casting molding. The transfer molding is a process in which a curable resin 440 is melted with sufficient pressure and heat by a mold press and is applied on the lead frame 410. The casting molding is a process in which the curable resin 440 is put in a vessel (typically referred to as a ‘mold cup’ in the LED process) by a dispenser. Examples of the curable resin include an epoxy resin, and a mixture with a fluorescent material, such as yttrium, aluminum, or garnet fluorescent material. The molding process is well known in the art and a detailed description thereof will thus be omitted herein.

As described above, the LED manufacture process is carried out through the die bonding, wire bonding, and molding that are carried out on the LED recesses 120 of the lower glass 100.

Another LED manufacture process will be described below. The adhesives 300 are applied on the LED recess 120 by a dispenser. The LED chip 420 is fixed with the adhesives 300 to the LED recess 120. The LED chip 420 and the electrode pattern 200 are wire-bonded to each other. After the wire bonding, a molding process is carried out by applying the curable resin 440 on the LED recess 120.

In this LED manufacture process, the LED chip 420 and the electrode pattern 200 are directly wire-bonded with each other without the lead frame. That is, the LED manufacture process is carried out during the backlight unit manufacture process. Accordingly, unlike a typical process of manufacturing LEDs, the lead frame 410 is not necessarily required to electrically connect the LED chip 420 to the electrode pattern 200.

As shown in FIG. 10(g), when the LED manufacture process is completed, the LEDs 400 are formed on the LED recesses 120. The LEDs 400 fixed on the LED recesses 120 are electrically connected to the electrode patterns 200, and give off light by current supplied from the electrode patterns 200. The LEDs 400 are connected in series to one another in column directions and connected in parallel to one another in row directions through the electrode patterns 200. However, the LEDs 400 may be connected to one another differently from the above-mentioned manner.

As shown in FIG. 10(h), the flat panel-shaped upper glass 500 having the same size as that of the lower glass 100 is stacked on the top surface of the lower glass 100 (operation S950). That is, the upper glass 500 and the lower glass 100 are joined together. A method of joining the glasses together is well-known in the art and a detailed description thereof will thus be omitted herein.

FIGS. 3, 4A, 4B and 4C are cross-sectional views of the backlight unit manufactured in this manner.

The method of manufacturing the backlight unit according to the present invention may further include the following operations.

First, diffusion patterns are formed on the top surface of the upper glass 500 (operation S930). The diffusion patterns are preferably formed on the same perpendicular lines with the LEDs 400 placed on the lower glass 100. The diffusion patterns act to diffuse light emitted from the LEDs 400. For this purpose, the diffusion patterns may have shapes shown in FIGS. 13(a), (b) and (c). The diffusion patterns of FIGS. 13(a), (b) and (c) may be formed on the top surface of the upper glass 500 by etching or sand blaster.

Secondly, a bottom surface of the upper glass 500 is formed to have a light-guide structure so that light emitted from the LEDs 400 can be uniformly diffused (operation S904). FIGS. 4A, 4B and 4C illustrate the bottom surface of the upper glass 500 having the light-guide structure.

Thirdly, a reflective material is applied on the bottom surface of the lower glass 100 (operation S960). Part of the light emitted from the LEDs 400 and diffused from the upper glass 500 having the light-guide structure is emitted to the opposite side and wasted. A reflective material having an excellent reflectance is applied on the bottom surface of the lower glass 100 to guide the wasted light back towards the upper glass 500. The reflective material may be AgCl.

The lower glass 100 may be stacked on a reflector made of a metallic material (operation S960). The reflector is preferably made of a metallic material, such as aluminum, with high reflective efficiency and thermal conductivity. A top surface of the reflector contacting the bottom surface of the lower glass 100 is preferably processed to have a smooth, flat surface, thereby enhancing the reflective efficiency.

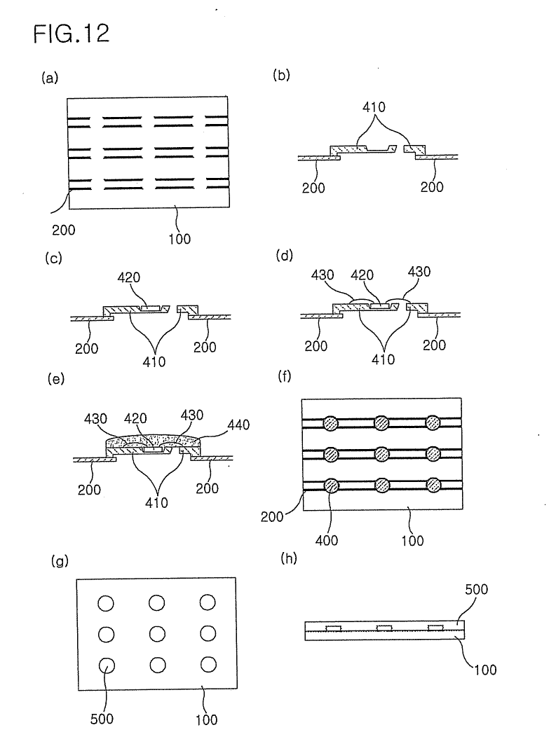

FIG. 11 is a flow chart of a method of manufacturing a backlight unit according to an embodiment of the present invention. FIG. 12 is a process-by-process backlight unit according to the method of FIG. 11.

As shown in FIG. 12(a), a plurality of electrode patterns 200 is formed on the top surface of the flat panel-shaped lower glass 100 by a printer and other apparatuses (operation S1100). The electrode patterns 200 may be formed on a plurality of electrode recesses after forming the electrode recesses. The electrode patterns 200 may be made of ITO. The electrode patterns 200 can be formed by the silk screen method.

After forming the electrode patterns 200, a process of manufacturing the LED 400 that are electrically connected to the electrode patterns 200 is performed (operation S1110). The LED manufacture process is performed in the order of die bonding, wire bonding, and molding. As shown in FIG. 12(b), the lead frame 410 is electrically connected and fixed to the electrode patterns 200. As shown in FIG. 12(c), the LED chip 420 is fixed on the lead frame 410 by the SMT equipment (Die bonding). Epoxy die bonding may be an example of the die bonding. The epoxy die bonding is one of the most popular methods in which a chip is attached with epoxy to a lead frame.

As shown in FIG. 12(d), after the die bonding, the LED chip 420 and the lead frame 410 are wire-bonded with a wire 430. A gold wire is typically used for wire-bonding. Examples of the bonding method include T/C bonding, T/S bonding, and U/S bonding.

After the wire bonding, a molding process is carried out to form a convex shape as shown in FIG. 10(f) or other shapes. Examples of the molding method include transfer molding and casting molding. The transfer molding is a process in which a curable resin 440 is melted with sufficient pressure and heat by a mold press and is applied on the lead frame. The casting molding is a process in which the curable resin 440 is put in a vessel (typically referred to as a ‘mold cup’ in the LED process) by a dispenser. Examples of the curable resin include an epoxy resin, and a mixture with a fluorescent material, such as yttrium, aluminum, or garnet fluorescent material. The molding process is well known in the art and a detailed description thereof will thus be omitted herein.

As described above, the LED manufacture process is carried out through the die bonding, wire bonding, and molding that are carried out on the LED recesses 120 of the lower glass 100.

Another LED manufacture process will be described below. The adhesives 300 are applied by a dispenser at positions where the LEDs are to be placed on the lower glass 100. The LED chip 420 is fixed with the adhesives 300 on the lower glass 100 by the SMT equipment. The LED chip 420 and the electrode pattern 200 are wire-bonded to each other. After the wire bonding, a molding process is carried out by applying the curable resin 440 on the LED chip 420.

In this LED manufacture process, the LED chip 420 and the electrode pattern 200 are directly wire-bonded with each other without the lead frame. That is, the LED manufacture process is carried out during the backlight unit manufacture process. Accordingly, unlike a typical process of manufacturing LEDs, the lead frame 410 is not necessarily required to electrically connect the LED chip 420 to the electrode pattern 200.

As shown in FIG. 12(f), the LEDs 400 are electrically connected to the electrode patterns 200, and give off light by current supplied from the electrode patterns 200. The LEDs 400 are connected in series to one another in column directions and connected in parallel to one another in row directions through the electrode patterns 200. However, the LEDs 400 may be connected to one another differently from the above-mentioned manner.

As shown in FIG. 12(g), a plurality of LED recesses 510 is formed on the bottom surface of the flat panel-shaped upper glass 500 by etching or sand blaster (operation S1120). The depth of the LED recess 510 is preferably larger than the height of the LED 400 to be inserted into the LED recess 510. As shown in FIG. 12(h), the upper glass 500 is stacked on the lower glass 100, such that the LEDs 400 fixed on the lower glass 100 are inserted into the LED recesses 120 of the upper glass 500 (operation S1150). The upper and lower glasses 500 and 100 are joined together. A method of joining the glasses together is well known in the art and a detailed description thereof will thus be omitted herein.

FIGS. 7 and 8 are cross-sectional views of the backlight unit manufactured according to the above-mentioned method.

The method of manufacturing the backlight unit according to the present invention may further include the following operations.

First, diffusion patterns are formed on the top surface of the upper glass 500 (operation S1130). The diffusion patterns are preferably formed on the same perpendicular lines with the LEDs 400 placed on the lower glass 100. The diffusion patterns act to diffuse light emitted from the LEDs 400. For this purpose, the diffusion patterns may have shapes shown in FIGS. 13(a), (b) and (c). The diffusion patterns of FIGS. 13(a), (b) and (c) may be formed on the top surface of the upper glass 500 by etching or sand blaster.

Secondly, a bottom surface of the LED recess 510 is formed to have a light-guide structure so that the light emitted from the LEDs 400 can be uniformly diffused (operation S1140). The bottom surface of the upper glass 500 may be formed as shown in FIG. 8.

Thirdly, a reflective material is applied on the bottom surface of the lower glass 100 (operation S1160). Part of the light emitted from the LEDs 400 and diffused from the upper glass 500 having the light-guide structure is emitted to the opposite side and wasted. A reflective material having an excellent reflectance is applied on the bottom surface of the lower glass 100 to guide the wasted light back towards the upper glass 500. The reflective material may be AgCl.

The lower glass 100 may be stacked on a reflector made of a metallic material (operation S1160). The reflector is preferably made of a metallic material, such as aluminum, with high reflective efficiency and thermal conductivity. A top surface of the reflector contacting the bottom surface of the lower glass 100 is preferably processed to have a smooth, flat surface, thereby enhancing the reflective efficiency.

As apparent from the above description, since the LEDs are placed on the LED recesses, it is possible to make the backlight unit thinner.

While the present invention has been described with reference to exemplary embodiments thereof, it will be understood by those skilled in the art that various changes in form and details may be made therein without departing from the scope of the present invention as defined by the following claims.

What is claimed is:

1. A method of manufacturing a backlight unit, comprising:
forming a plurality of LED recesses and a plurality of electrode recesses on a top surface of a flat panel-shaped lower glass;
forming electrode patterns on the electrode recesses to supply current to LEDs;
applying adhesives on the LED recesses;
fixing the LEDs on the adhesives applied on the LED recesses; and
stacking a flat panel-shaped upper glass on the top surface of the lower glass.

2. The method of claim 1, further including forming diffusion patterns on a top surface of the upper glass to diffuse light emitted from the LEDs.

3. The method of claim 1, further including forming a light-guide structure on a bottom surface of the upper glass so that the light emitted from the LEDs can be uniformly diffused.

4. The method of claim 1, further including forming a reflector on a bottom surface of the lower glass.

5. The method of claim 4, wherein the reflector is made of a metallic material having high thermal conductivity.

6. A method of manufacturing a backlight unit, comprising:
forming electrode patterns on a flat panel-shaped lower glass;
applying adhesives at positions of the lower glass where LEDs are to be attached;
fixing the LEDs to the adhesives;
forming a plurality of LED recesses on a bottom surface of a flat panel-shaped upper glass; and
stacking the upper glass on a top surface of the lower glass so that the LEDs fixed on the lower glass can be placed on the LED recesses of the upper glass.

7. The method of claim 6, further including forming diffusion patterns on a top surface of the upper glass to diffuse light emitted from the LEDs.

8. The method of claim 7, further including forming a light-guide structure on a bottom surface of each of the LED recesses so that the light emitted from the LEDs can be uniformly diffused.

9. The method of claim 6, further including forming a reflector on a bottom surface of the lower glass.

10. The method of claim 9, wherein the reflector is made of a metallic material having high thermal conductivity.

11. A method of manufacturing a backlight unit, comprising:
forming a plurality of LED recesses and a plurality of electrode recesses on a top surface of a flat panel-shaped lower glass;
forming electrode patterns on the electrode recesses to supply current to LEDs;
performing a process of manufacturing LEDs to be fixed on the LED recesses; and
stacking a flat panel-shaped upper glass on the top surface of the lower glass.

12. The method of claim 11, wherein the operation of performing a process of manufacturing LEDs includes:
fixing LED chips on the LED recesses;
electrically connecting the electrode patterns and the LED chips; and
molding the LED chips.

13. The method of claim 12, further including forming diffusion patterns on a top surface of the upper glass to diffuse light emitted from the LEDs.

14. The method of claim 12, further including forming a light-guide structure on a bottom surface of the upper glass so that the light emitted from the LEDs can be uniformly diffused.

15. The method of claim 11, further including forming a reflector on a bottom surface of the lower glass.

16. The method of claim 15, wherein the reflector is made of a metallic material having high thermal conductivity.

17. A method of manufacturing a backlight unit, comprising:
forming electrode patterns on a flat panel-shaped lower glass;
performing a process of manufacturing LEDs that are fixed on the lower glass and emit light by current supplied from the electrode patterns;
forming a plurality of LED recesses on a bottom surface of a flat panel-shaped upper glass; and
stacking the upper glass on a top surface of the lower glass so that the LEDs fixed on the lower glass can be placed on the LED recesses of the upper glass.

18. The method of claim 17, wherein the operation of performing a process of manufacturing LEDs includes:
fixing LED chips on the LED recesses;
electrically connecting the electrode patterns and the LED chips; and
molding the LED chips.

19. The method of claim 18, further including forming diffusion patterns on a top surface of the upper glass to diffuse light emitted from the LEDs.

20. The method of claim 18, further including forming a light-guide structure on a bottom surface of each of the LED recesses so that the light emitted from the LEDs can be uniformly diffused.

21. The method of claim 17, further including forming a reflector on a bottom surface of the lower glass.

22. The method of claim 21, wherein the reflector is made of a metallic material having a high thermal conductivity.

23. A backlight unit comprising:
a flat panel-shaped lower glass having a plurality of LED recesses and a plurality of electrode recesses formed on its top surface;
LEDs fixed on the LED recesses;
electrode patterns formed on the electrode recesses to supply current to the LEDs; and
a flat panel-shaped upper glass stacked on a top surface of the lower glass.

24. The backlight unit of claim 23, wherein the upper glass has diffusion patterns on its top surface to diffuse light emitted from the LEDs.

25. The backlight unit of claim 23, wherein a bottom surface of the upper glass has a light-guide structure so that light emitted from the LEDs can be uniformly diffused.

26. The backlight unit of claim 23, further including a reflector formed on a bottom surface of the lower glass.

27. The backlight unit of claim 26, wherein the reflector is made of a metallic material having high thermal conductivity.

28. A backlight unit comprising:
a flat panel-shaped lower glass;
a plurality of LEDs fixed on the lower glass;
a plurality of electrode patterns formed on the lower glass to supply current to the LEDs; and
a flat panel-shaped upper glass that has a plurality of LED recesses formed on its bottom surface and is stacked on the lower glass so that the LEDs can be placed on the LED recesses.

29. The backlight unit of claim 28, wherein the upper glass has diffusion patterns on its top surface to diffuse light emitted from the LEDs.

30. The backlight unit of claim 28, wherein a bottom surface of each of the LED recesses has a light-guide structure so that the light emitted from the LEDs can be uniformly diffused.

31. The backlight unit of claim 28, further including a reflector formed on a bottom surface of the lower glass.

32. The backlight unit of claim 31, wherein the reflector is made of a metallic material having high thermal conductivity.
